(19) United States
(12) Patent Application Publication
(10) Pub. No.: US 2012/0236199 A1
(43) Pub. Date: Sep. 20, 2012

(54) INFORMATION PROCESSING APPARATUS, IMAGE TRANSMITTING PROGRAM, IMAGE TRANSMITTING METHOD AND IMAGE DISPLAY METHOD

(75) Inventors: Tomoharu IMAI, Kawasaki (JP); Kazuki Matsui, Kawasaki (JP)

(73) Assignee: FUJITSU LIMITED, Kawasaki-shi (JP)

(21) Appl. No.: 13/412,926

(22) Filed: Mar. 6, 2012

(30) Foreign Application Priority Data
Mar. 14, 2011 (JP) 2011-055995

(51) Int. Cl. H04N 7/26; H04N 11/02

(52) U.S. Cl. 348/415.1; 348/E11.006

(57) ABSTRACT

An information processing apparatus that creates video data for displaying a computer execution result on a display unit of a terminal device connected via a network and transmits the video data to the terminal device, the information processing apparatus including a memory for storing time sequential static image data constituting the video data, and a processor for a first transmitting the time sequential static image data in order to the terminal device, and a second transmitting, alternatively with the first transmitting, after creating and transmitting reference image data that becomes a reference in the time sequential static image data, difference image data from previous static image data in order, wherein the second transmitting does not transmit the reference image data and transmits a signal indicating that the last static image data transmitted by the first transmitting is to be reference image data, when switched from the first transmitting.

### CROSS-REFERENCE TO RELATED APPLICATION

This application is based upon and claims the benefit of priority of the prior Japanese Patent Application No. 2011-55995, filed on Mar. 14, 2011, the entire contents of which are incorporated herein by reference.

### FIELD

Aspects of the present embodiment relate to an information processing apparatus, an image transmitting program, an image transmitting method, and an image display method.

### BACKGROUND

A system called a thin client is known in the art. A thin client system is one which allows the client to only have minimal functions so that resources such as applications and files can be managed in a server.

Such a thin client system allows processing results actually processed by the server and data held by the server to be displayed by the client while the system behaves as if the client is independently conducting the processing and holding the data. Protocols used for communication within the thin client system include, for example, Remote Desktop Protocol (RDP) and Remote Frame Buffer (RFB) protocol used in Virtual Network Computing (VNC).

In addition to document creation applications and browsers, Computer-Aided Design (CAD) applications may also be used in a thin client system. Processing to create circuit board wiring or 3D modeling with data called wire frame data is conducted in CAD applications. In addition, depending on the type of data, work called rendering which involves creating very detailed drawing data, and other work such as viewing a wire frame model from various angles to look at the entire model or at portions for defects and problem spots is conducted. However to do so, a large amount of data has to be transferred when using CAD applications and the like in a thin client system.

When using such applications, several hundreds of megabits per second of network bandwidth is consumed when transferring all the image data without modification. As a result, the data is transferred after conducting compression processing when transferring the image data. When conducting compression processing, an amount of data over a specific period of time is changed due to a trade-off between the quality and the amount of data.

However, increases and decreases occur in the time slots and even in the connected network itself when the available network bandwidth changes slightly. Further, since the desired network bandwidth is different according to the application being used, the desired network bandwidth may be insufficient when compressing or transferring data simply according to one compression method or a specific image quality setting. As a result, a problem occurs in that the compressed graphic data is not transferred due to the shortage of network bandwidth. Moreover, another problem occurs since image quality is not improved when an appropriate amount of the available network bandwidth is not used. These problems are not limited to the treatment of graphic or video data and the same problems occur when transferring large amounts of data between the client and the server when updating images in the thin client system.

As a result, techniques to reduce data transfers amounts between the server and the client to improve operating response have been disclosed. As one example, there is a technique for optimizing transfer amounts by applying image compression methods having different compression ratios according to the currently available network bandwidth when transferring display image data. When the available bandwidth is low, this technique allows for the data transfer amount to be greatly reduced in exchange for a reduction in the image quality by allowing for the compression of the image data using a lossy compression method. In contrast, when a large bandwidth is available, high quality image data is transferred while consuming a large amount of the bandwidth by allowing the data to be transferred without compression or with compression using a lossless compression method. In this way, this technique maintains an appropriate transfer amount and image quality by switching the method according to the network bandwidth conditions (see International Patent Publication No. 2005-029864).

### SUMMARY

According to an aspect of the invention, an information processing apparatus that creates video data for displaying a computer execution result on a display unit of a terminal device connected via a network and transmits the video data to the terminal device, the information processing apparatus including a memory for storing time sequential static image data constituting the video data, and a processor for a first transmitting the time sequential static image data constituting the video data in order to the terminal device, and a second transmitting, alternatively with the first transmitting, after creating and transmitting reference image data that becomes a reference in the time sequential static image data constituting the video data, difference image data from previous static image data in order, wherein the second transmitting does not transmit the reference image data and transmits a signal indicating that the last static image data transmitted by the first transmitting is to be reference image data, when switched from the first transmitting.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 illustrates a thin client system configuration according to a first embodiment.

FIG. 2 describes a system flow according to the first embodiment.

FIG. 3 is an example of an image transmitted by a server device to a client device.

FIG. 4 is an example of a client operation.

FIG. 5 is an example of a client device using difference image processing to create a video.

FIG. 6 is a block diagram of configurations of devices in a system according to a second embodiment.

FIG. 7 illustrates an example of internal processing of an update difference video converting unit.

FIG. 8 illustrates an example of internal processing of a video data processing unit.

FIG. 9 is a flow chart of an overall process flow conducted by a server device according to the second embodiment.

FIG. 10 is a flow chart of frame buffer accumulation processing conducted by the server device according to the second embodiment.

FIG. 11 is a flow chart of simulated I-frame creation processing conducted by the server device according to the second embodiment.

FIG. 12 is a flow chart of update difference video creation processing conducted by the server device according to the second embodiment.

FIG. 13 is a flow chart of an overall flow of processing conducted by a client device according to the second embodiment.

FIG. 14 is a flow chart of simulated I-frame processing conducted by the client device according to the second embodiment.

FIG. 15 is a flow chart of video data processing conducted by the client device according to the second embodiment.

FIG. 16 is a block diagram of a configuration of a server device according to a third embodiment.

FIG. 17 is a flow chart of update difference video creation processing conducted by the server device according to the third embodiment.

FIG. 18 is a flow chart of simulated I-frame creation processing conducted by the server device according to the third embodiment.

FIG. 19 is a block diagram of a configuration of a server device according to a fourth embodiment.

FIG. 20 is a flow chart of simulated I-frame creation processing conducted by the server device according to the fourth embodiment.

FIG. 21 is a block drawing of a hardware configuration of a computer that executes an image transmitting program.

### DESCRIPTION OF EMBODIMENTS

However, a problem occurs in the conventional technique when the amount of data to be transferred is large.

For example, a case can be envisioned in which screen data is compressed and transferred as an image at one point in time, but the processing may be switched to processing for compressing and transferring the screen data as video data at the next point in time due to a change in the network bandwidth or in the application in use. In this case, when compressing the screen data as video data, compression on screen data compressed according to images is conducted from the screen in which the next update has occurred.

However, updating is rarely conducted independently in all the regions between the screen compressed as an image (hereinbelow called a front frame) and the screen compressed as a video (hereinbelow called a rear frame), and thus the front frame and the rear frame have a similarity relationship. This relationship is generally used when compressing only with video so that frames including only difference data (hereinbelow called P-frames) are transmitted so that a display can be realized with a small amount of data. However in the conventional art, data updating is not conducted using difference data in this way. Instead, video data is created from frames including all the data of the target regions made up from the difference data source (hereinbelow called I-frames) which is then compressed and transferred as screen data.

For example, since data of the front frames transferred as image data, and data of the rear frames transferred as video data is compressed and transmitted as I-frames in the video data regardless of the similarity, the transfer of redundant data occurs. Specifically, static images that make up a large amount of the data transfer are duplicated and transmitted and therefore it is difficult to say that the amount of transferred data has been reduced.

Considering the above problem, it is an object of the embodiments to provide an information processor apparatus, an image transmitting program, an image transmitting method, and an image display method that can reduce data transfer amounts.

Hereinbelow, embodiments of an information processor, an image transmitting program, an image transmitting method, and an image display method will be described in detail with reference to the drawings. The present disclosure is not limited to the embodiments disclosed herein.

### Embodiment 1

An overall configuration of a thin client system, a configuration of the devices, and a processing flow that make up the thin client system will be described in the first embodiment.

(Overall Configuration)

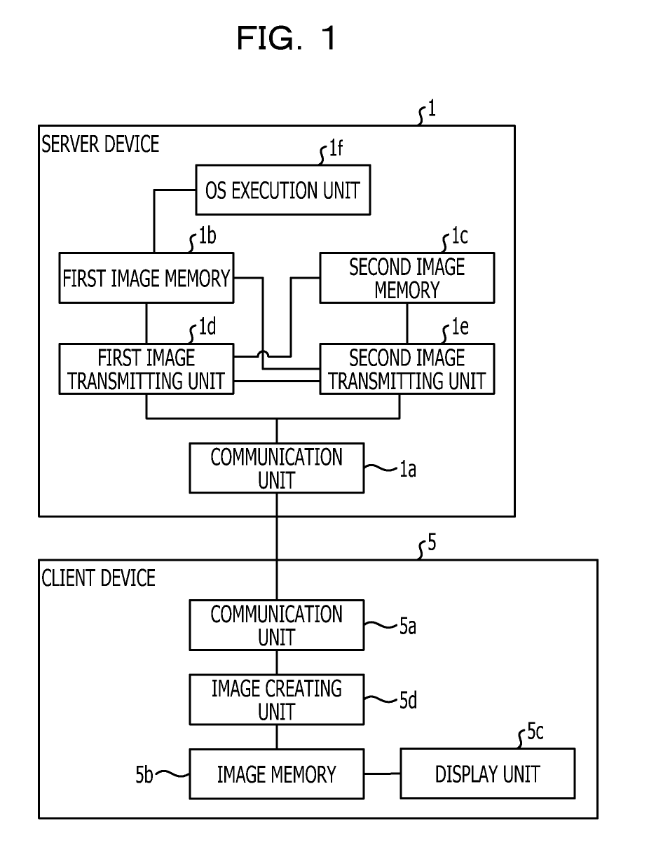

FIG. 1 illustrates a thin client system configuration according to the first embodiment. As illustrated in FIG. 1, the system includes a server device 1 and a client device 5. The number of devices is merely an example and is not limited as such.

A screen displayed by the client device 5 is remotely controlled by the server device 1 in the thin client system. Specifically, the thin client system causes processing results actually conducted by the server device 1 and data actually held by the server device 1 to be displayed on the client device 5 so that the client device 5 seems to behave as if the client device 5 itself is conducting the processing and holding the data.

The server device 1 and the client device 5 are communicably interconnected via a specific network. The network may be wired or wireless, and any type of communication system such as the Internet, a Local area Network (LAN), or a Virtual Private Network (VPN) may be used. A Remote Frame Buffer (RFB) protocol for Virtual Network Computing (VNC) may be used as an example of a communication protocol between the server device 1 and the client device 5.

The server device 1 is a computer that provides a service to remotely control a screen to be displayed by the client device 5. For example, after acquiring operating information from the client device 5, the server device 1 executes a process requested by the operation using an application run by the server device 1 itself. The server device 1 then creates a screen for displaying the processing result executed by the application and transmits the screen to the client device 5.

The client device 5 is a computer on the side that receives the remote screen control service provided by the server device 1. Examples of such a client device 5 include a fixed terminal such as a personal computer, or a mobile terminal such as a mobile telephone, a Personal Handyphone System (PHS), or a Personal Digital Assistant (PDA).

(Server Configuration)

As illustrated in FIG. 1, the server device 1 includes a communication unit 1a, a first image memory 1b, a second image memory 1c, a first image transmitter 1d, a second image transmitter 1e, and an Operating System (OS) execution unit if. The communication unit 1a is an interface that controls communication with the client device 5, transmits images and the like to the client device 5, and receives operations and the like executed on the client device 5.

The first image memory 1b retains execution results of drawing processing conducted on a desktop screen by an application run on the OS and by the OS itself executed on the computer. Specifically, the first image memory 1b retains the latest image data of the desktop screen that will become source data to be provided to the client device 5 by the server device 1 as the remote screen control service.

The second image memory 1c retains images transmitted by the first image transmitter 1d described below. Specifically, the second image memory 1c retains transmitted image data provided to the client device 5 by the server device 1 as the remote screen control service. For example, the second image memory 1c retains a transmitted remote screen transmitted in order and in a time sequence. Update images from the OS and the application are written in the first image memory 1b asynchronously at different intervals. Conversely, the first image transmitter 1d is not limited to acquiring data each time the data is written to an image memory by the OS execution unit 1f. Moreover, there is a possibility that data transmitted to the client might not be synchronized when copying data directly from the first image memory 1b to the second image memory 1c. Thus, the server device 1 copies the image memory data to the second image memory 1c through the first image transmitter 1d.

The first image transmitter 1d acquires data retained in the first image memory 1b at certain intervals and transmits the acquired data to the client device 5 and also transmits (copies) the acquired data to the second image memory 1c. For example, after acquiring operating information from the client device 5, the OS execution unit if executes a process requested by the operation using an application to run the operation in the server device 1 itself. The OS execution unit if then creates images for displaying the processing results executed by the application and stores the created images in the first image memory 1b. The first image transmitter 1d conducts a conversion process after copying at a certain timing the images stored in the first image memory 1b, and transmits the images to the client device 5. The image memory data used in the conversion process is stored in the second image memory 1c at the same time that the image memory data is transmitted.

The second image transmitter 1e establishes the latest images of the images retained in the second image memory 1c as reference images when the transmitting is switched from the first image transmitter 1d to the second image transmitter 1e. The second image transmitter 1e then acquires image data at certain intervals from the first image memory 1b and creates difference images based on the reference images, and transmits to the client device 5 the difference images and signals to acquire the reference images from the transmitted images.

For example, the second image transmitter 1e changes the transmission method from the image transmission that is conducted by the first image transmitter 1d to video transmission at a specific moment. The second image transmitter 1e then decides that the remote screen displayed by the client device 5, that is, the latest images retained in the second image memory 1c, at the timing of switching the transmission method represents the reference images. The second image transmitter 1e then creates image transmission data after the switch as the difference images based on the reference images. The difference images are created by acquiring the screen data from the first image memory 1b at specific intervals by the second image transmitter 1e, and comparing the acquired screen data with the reference images. The second image transmitter 1e then transmits to the client device 5 the difference images and the signals to acquire the reference images from the images previously transmitted to the client device 5.

Specifically, the second image transmitter 1e uses the so-called I-frames only when creating the P-frames and then transmits only the P-frames to the client device 5 when switching from image transmission to video transmission.

(Client Device Configuration)

As illustrated in FIG. 1, the client device 5 includes a communication unit 5a, an image memory 5b, a display unit 5c, and an image creating unit 5d. The communication unit 5a is an interface that controls communication with the server device 1, and, for example, receives images and the like from the server device 1 and transmits operating information to the server device 1.

The image memory 5b retains images received from the server device 1. For example, the image memory 5b retains the results of expansion and decoding processing on images received as remote screens conducted by the image creating unit 5d. The display unit 5c is a display device such as a display or touch panel that displays image data written in the image memory, and works in concert with a mouse and the like to provides a pointing device.

The image creating unit 5d stores images received from the server device 1 in the image memory 5b when the images are received. The image creating unit 5d also acquires images saved in the image memory 5b and designates the images as simulated reference images when difference images and the signals to acquire the reference images from the transmitted images are received. The image creating unit 5d uses the simulated reference images and the received difference images to create video images and then stores the created video images in the image memory 5b. The OS in the client device 5 then reads out the video images from the image memory 5b and reproduces the video images as the remote screen on the display unit 5c.

Specifically, the image creating unit 5d decides that the images displayed on the display unit 5c immediately before represent a simulated I-frame when a P-frame and certain signals are received from the server device 1. The image creating unit 5d then uses the simulated I-frame and the received P-frame to reproduce the video images.

(Process Flow)

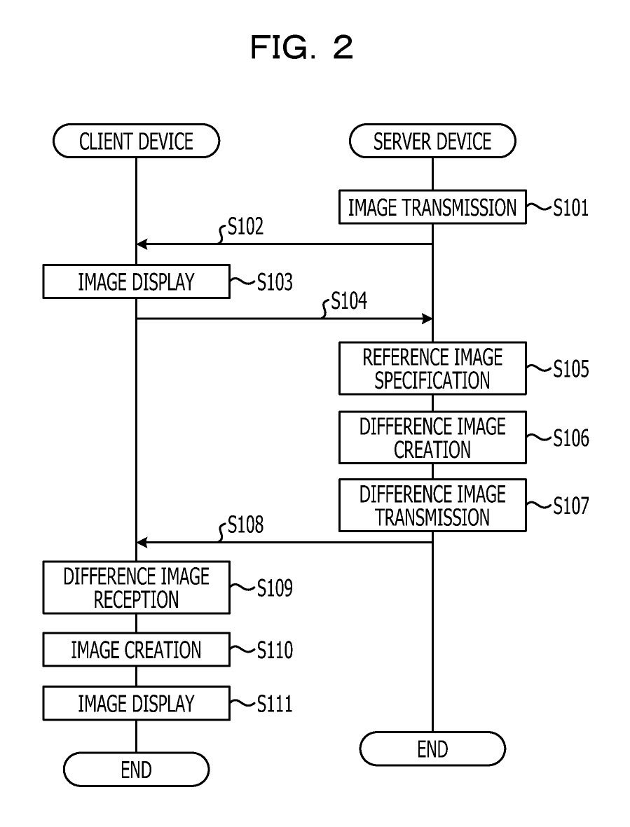

FIG. 2 describes a system flow according to the first embodiment. As illustrated in FIG. 2, the first image transmitter 1d of the server device 1 transmits images from an updated region acquired from the first image memory 1b to the client device 5 as difference images (S101 and S102). Specifically, after acquiring operating information of the client device 5, the server device 1 executes a process requested by the operation using an application run by the server device 1 itself, creates images to display the executed processing results, and then sends the created images to the client device 5.

The image creating unit 5d of the client device 5 that receives the images stores the images received from the server device 1 in the image memory 5b, and the images are outputted to the display unit 5c (S103).

The second image transmitter 1e of the server device 1 that conducts detecting at specific moments determines that the transmission method has switched and then, at the timing of switching the transmission method, specifies the remote screen displayed by the client device 5 as the reference images (S104 and S105). In other words, the second image transmitter 1e decides that the latest images retained in the second image memory 1c are the reference images.

Based on the reference images, the second image transmitter 1e then creates difference images from the reference images up to the images displayed by the client device 5 by acquiring the images retained in the first image memory 1b and comparing the acquired images with the reference images (S106).

The second image transmitter 1e then transmits to the client device 5 the difference images and the signals to acquire the reference images from the images transmitted to the client device 5 (S107 and S108).

The image creating unit 5d of the client device 5 that receives the difference images and the signals designates the images immediately before receiving the difference images, in other words the latest images displayed on the display unit 5c, as simulated reference images, and then uses the simulated reference images and the difference images to create video images (S109 and S110). The image creating unit 5d then stores the created video images in the image memory 5b and causes the video images to be displayed on the display unit 5c as the remote screen (S111).

(Detailed Example of Transmission Method Switch)

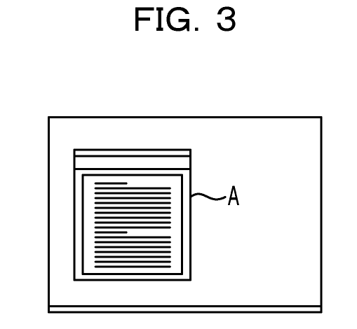

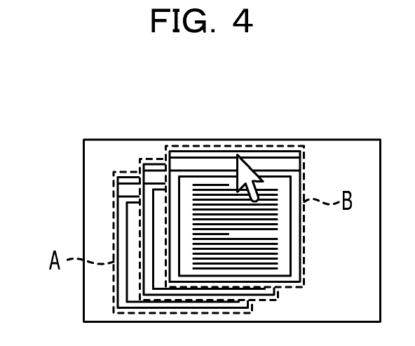

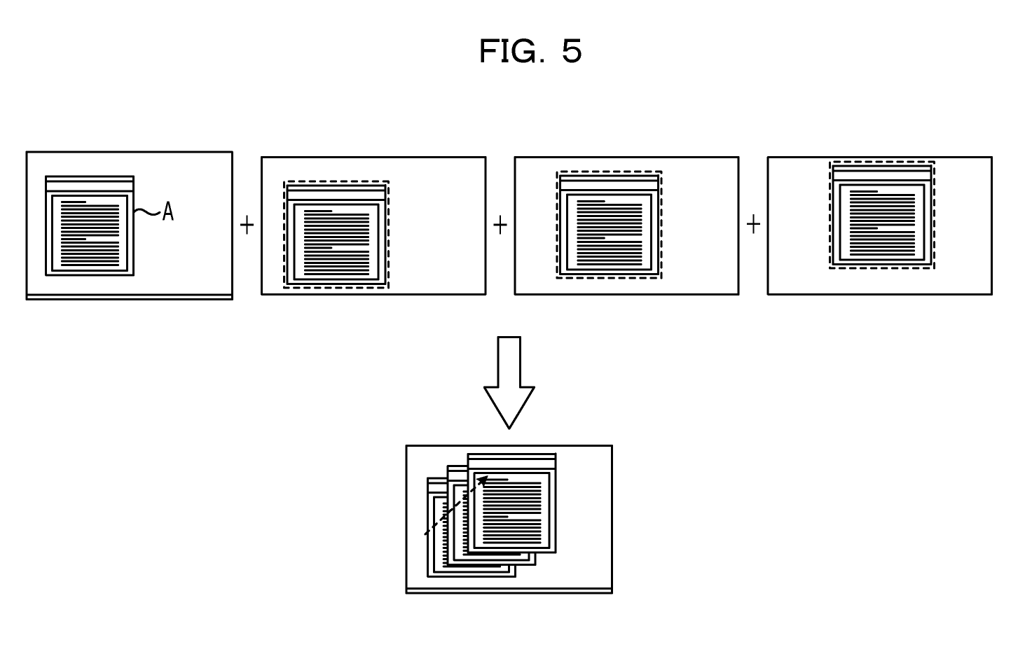

The following is an exemplary description of an image transmission method executed by the system illustrated in FIG. 1 with reference to FIGS. 3 to 5. FIG. 3 is an example of an image transmitted by a server device to a client device. FIG. 4 is an example of a client operation. FIG. 5 is an example of a client device using difference image processing to create video images.

The server device 1 first creates an image A illustrated in FIG. 3 and transmits the image A to the client device 5. As illustrated in FIG. 4, an image operation to cause the displayed image A to be moved a specific value or more is executed in the client device 5. The server device 1 switches the image transmission method triggered by the image operation illustrated in FIG. 4.

The server device 1 designates the image A illustrated in FIG. 3 displayed in the client device 5 up to the execution of the image operation in FIG. 4, as a reference image, and then, based on the reference image, creates difference images from the image A up to the image B illustrated in FIG. 4. The server device 1 then transmits the created difference images and signals to acquire the reference image from the transmitted image, to the client device 5. When moving from the image A to the image B, the reference image is changed to the sum of the difference images of the frames up to that point.

As illustrated in FIG. 5, video images are created using the received difference images and the simulated reference image of the image A illustrated in FIG. 3, which is the image received immediately before receiving the reference image, and the video images are reproduced on the display unit 5c of the client device 5.

(Effects of the First Embodiment)

In the system according to the first embodiment, the amount of data transferred can be reduced without redundancy by using frames that exist in both the server device and the client device as simulated reference images in scenes in which screen update data is transmitted while switching the compression method. Specifically, despite that fact that the server device 1 does not transmit a large data transfer amount of static images, video images can be displayed in the client device 5. Therefore, the data transfer amount can be reduced.

### Embodiment 2

Next, an example will be described of switching from static image transmission to Moving Picture Expert Group (MPEG) transmission when a server device normally transmits static images to a client server and a trigger is detected. The following will describe configurations of the devices included in the system, a processing flow, and the effects. The exemplary compression method used hereinbelow may be MPEG-2 or MPEG-4, but the embodiment is not limited to these compression methods.

(Configurations of Devices)

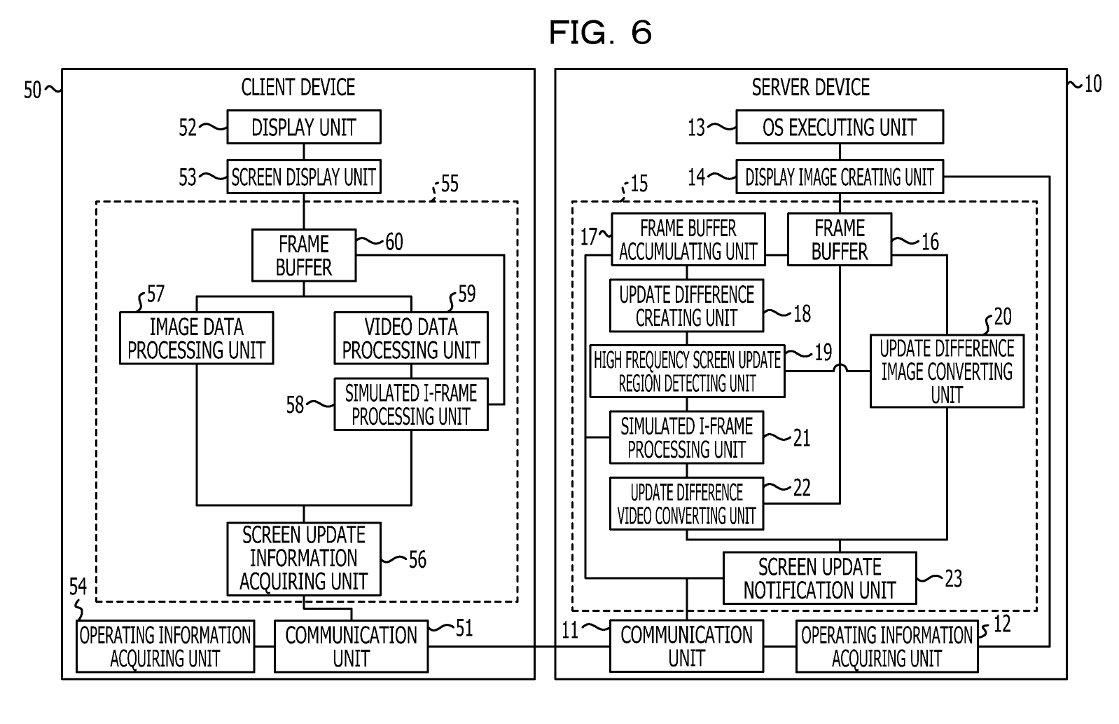

FIG. 6 is a block diagram of configurations of devices in a system according to a second embodiment. As illustrated in FIG. 6, the system includes a server device 10 and a client device 50, and the configurations of the devices will be described.

(Server Configuration)

As illustrated in FIG. 6, the server device 10 includes a communication unit 11, an operating information acquiring unit 12, an Operating System (OS) executing unit 13, a display screen creating unit 14, and a server side remote screen controlling unit 15. In the example of FIG. 6, it is assumed that, besides the functional units illustrated in FIG. 6, a conventional computer includes various functional units such as various input and display devices.

The communication unit 11 is a communication interface that sends and receives data to and from the client device 50. For example, the communication unit 11 transmits images and difference images outputted by a belowmentioned screen update notifying unit 23 to the client device 50. The communication unit also receives operating information from the client device 50 and outputs the operating information to the operating information acquiring unit 12.

The operating information acquiring unit 12 is a processing unit that acquires the client device 50 operating information received by the communication unit 11. For example, the operating information acquiring unit 12 acquires operating information such as mouse cursor movement amounts and the like obtained through mouse movement operations such as a mouse right-click, double-click, and dragging. As another example, the operating information acquiring unit 12 acquires operating information such as mouse wheel scroll amounts and various types of keys pressed on a keyboard. As a detailed example, the operating information acquiring unit 12 may acquire the time taken between down and up click motions of a mouse or a distance between down and up click motions of a mouse acquired from the client device 50.

The OS execution unit 13 is a processing unit that executes an OS inside the server. For example, the OS execution unit 13 detects application start instructions and commands for applications from the operating information acquired by the operating information acquiring unit 12. As one example, the OS execution unit 13 instructs the display screen creating unit 14 to start an application corresponding to an icon of that application when it is detected that the icon is double-clicked. As another example, the OS execution unit 13 instructs the display screen creating unit 14 to execute a command when an operation requesting the execution of that command is detected on an active application operating screen, or a so-called window.

The display screen creating unit 14 is a processing unit that controls the execution of applications and executes screen creation according to instructions from the OS execution unit 13. As one example, the display screen creating unit 14 runs an application when instructed to start an application or instructed to execute a command for an active application by the OS execution unit 13. The display screen creating unit 14 then creates a display image (remote screen) of a processing result obtained by executing the application and writes the display screen image into a frame buffer 16.

Applications executed by the display screen creating unit 14 may be pre-installed or may be installed after shipping the server device 10. Such applications also include ones operated by automatically reading data from a network environment such as JAVA (registered trademark) and the like. The display screen creating unit 14 may also include a driver and the like that writes display images into the frame buffer 16, or in other words, draws the display images in the frame buffer 16.

The server side remote screen controlling unit 15 is a processing unit that provides to the client device 50 a remote screen control service using an application for controlling a server side remote screen. As illustrated in FIG. 6, the server side remote screen controlling unit 15 includes the frame buffer 16, a frame buffer accumulating unit 17, an update difference creating unit 18, a high frequency screen update region detecting unit 19, and an update difference image converting unit 20. The server side remote screen controlling unit 15 also includes a simulated I-frame processing unit 21, an update difference video converting unit 22, and a screen update notification unit 23.

The frame buffer 16 is a memory device for storing display images drawn by the display screen creating unit 14 as image data frames. A semiconductor memory element such as a Random Access Memory (RAM), a Video Random Access Memory (VRAM), a Read Only Memory (ROM), or a flash memory may be included as an mode of the frame buffer 16. The frame buffer 16 may also use a storage device such as a hard disc or an optical disk.

The frame buffer accumulating unit 17 is a storage disc that accumulates past frame buffer states as history and may use the same types of devices as the frame buffer 16. For example, the frame buffer accumulating unit 17 has a function to accumulate past screen data frames written in the server side frame buffer 16. Specifically, the frame buffer accumulating unit 17 scans an entire screen once and counts the occurrence of a difference detection as one frame and then accumulates the frames one frame at a time when screen information difference detection processing is being conducted in the server device 10.

As an example, the frame buffer accumulating unit 17 periodically acquires and retains all the frame information at a certain point of time, and outputs the retained data according to a request from another processing unit. The frame buffer accumulating unit 17 receives a request from the update difference creating unit 18 to acquire frame buffer screen data frames at a timing, for example, to check the frame buffer once every 33 ms or the like. During the acquiring, the frame buffer accumulating unit 17 retains all the information of the frames at the timing as well as a frame number at that time. The frame number is a value that increases by one when a frame buffer is checked.

The update difference creating unit 18 is a processing unit that inspects the frame buffer 16 and detects updated difference portions. For example, upon receiving screen data frames from the frame buffer accumulating unit 17, the update difference creating unit 18 compares the currently received screen data frames with the screen data received at the previous timing to detect difference portions. The update difference creating unit 18 then outputs the detected difference portions to the high frequency screen update region detecting unit 19.

The high frequency screen update region detecting unit 19 is a processing unit that uses the updated differences acquired from the update difference creating unit 18 to detect regions of intense updating in the frame buffer. The high frequency screen update region detecting unit 19 may use various methods to detect the regions of intense updating. As one example, the high frequency screen update region detecting unit 19 creates an updated rectangle that indicates a rectangle that was updated from the acquired difference portions. If the created updated rectangle is an animated region, the high frequency screen update region detecting unit 19 detects the updating as an intense region.

For example, the high frequency screen update region detecting unit 19 detects the updated rectangle as an animated region if the size of the updated rectangle is equal to or greater than a certain value, or if the number of difference image frames displaying the rectangle is equal to or greater than a certain value. Specifically, the high frequency screen update region detecting unit 19 detects whether or not intense operations were conducted by the client device 50 in the screen data frames previously transmitted to the client device 50 by the server device 10. The high frequency screen update region detecting unit 19 then sends a video image creation request to the simulated I-frame processing unit 21 if it is determined that an intense operation was conducted, and sends an updated image transmission request to the update difference image converting unit 20 if it is determined that an intense operation was not conducted.

Upon receiving the updated image transmission request from the high frequency screen update region detecting unit 19, the update difference image converting unit 20 acquires from the frame buffer 16 a region matching the updated differences from the region of the frequent updates and converts the updated differences to images, and then outputs the converted images to the screen update notification unit 23. Specifically, the update difference image converting unit 20 determines that an image operation was conducted within a permissible range in the screen data frames previously transmitted to the client device 50 by the server device 10. In this case, the update difference image converting unit 20 uses the data stored in the frame buffer accumulating unit 17 and the frame buffer 16 to create difference images based on the previously transmitted screen data frames.

The simulated I-frame processing unit 21 is a processing unit that outputs useable frame information as I-frames when the updated difference is converted to video images. The simulated I-frame processing unit 21 then uses the frame information to acquire screen data that becomes the simulated I-frame data from the frame buffer accumulating unit 17, and outputs the screen data to the update difference video converting unit 22.

Specifically, the simulated I-frame processing unit 21 acquires from the frame buffer accumulating unit 17 the latest frame buffer that has currently been transmitted. The simulated I-frame processing unit 21 acquires the screen data of the region subject to the conversion from frame data to video data and outputs the screen data to the update difference video converting unit 22 as simulated I-frames. For example, the simulated I-frame processing unit 21 receives from the high frequency screen update region detecting unit 19 information of a high frequency screen update region that is desirably converted to video data. The simulated I-frame processing unit 21 also acquires the transmitted frame numbers up to the present time from the screen update notification unit 23. The data from the transmission conducted by the screen update notification unit 23 is assumed to have reached the client side. The simulated I-frame processing unit 21 then acquires from the frame buffer accumulating unit 17 information of the frames corresponding to the transmitted frame numbers. The simulated I-frame processing unit 21 outputs the screen data to the update difference video converting unit 22 as simulated I-frames.

The update difference video converting unit 22 is a processing unit that creates video data without the leading I-frame by using the data created in a state in which the simulated I-frames were previously transferred and acquired from the frame buffer 16 based on the I-frames. For example, the update difference video converting unit 22 receives from the simulated I-frame processing unit 21 the simulated I-frames and information about the high frequency screen update region, and then compares the simulated I-frame data with the current frame buffer as I-frames. The update difference video converting unit 22 then creates video data in which the beginning of the data begins with a P-frame, and then transfers the created video data to the screen update notification unit 23.

MPEG technology may be used to convert the screen update difference data in the update difference video converting unit 22. Video data is created in the MPEG technology using only frames with the following two different characteristics. Firstly, data called an I-frame is created at the beginning of the video data. The I-frame becomes the foundation of other frames (P-frames) and represents independent data that can be displayed as one image with only this frame. Secondly, data called a P-frame is created. The P-frame is a frame that includes only difference data that is different from the I-frame. A complete screen can be created by using the P-frames in relation to the I-frames. Consequently, an image is not created using only a P-frame. Moreover, P-frames can be continuously made after the I-frame.

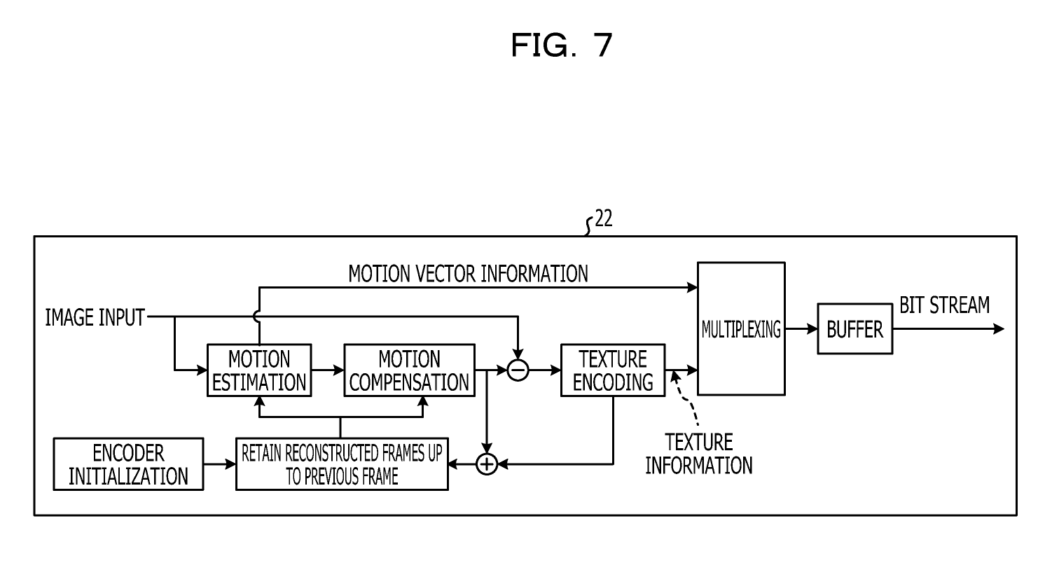

The following is an explanation of MPEG encoding conducted by the update difference video converting unit 22. FIG. 7 illustrates an example of internal processing of an update difference video converting unit. As illustrated in FIG. 7, the update difference video converting unit 22 that is an MPEG encoder conducts processing such as motion estimation, motion compensation, texture encoding, multiplexing and the like in the same way as a typical encoder to create video data. A feature that is different from a typical encoder in the processing conducted by the update difference video converting unit 22 is that a processing region frame buffer is inputted as an I-frame when the encoding is initialized. Detailed explanations of processing similar to that conducted by a typical encoder will be omitted.

Specifically, the update difference video converting unit 22 first acquires from the simulated I-frame processing unit 21a screen data position of a high frequency screen update region in the past frame buffer as a replacement of the I-frames when making MPEG data. The acquisition of the past screen data is conducted for the use of the frame buffers already being transmitted to the client side. Next, the update difference video converting unit 22 writes the acquired screen data as simulated I-frames into the buffer retaining the “reconstructed frames up to the previous screen” as simulated I-frames. This processing allows for the creation of video data from the P-frames without creating leading I-frames in the data created during encoding.

The update difference video converting unit 22 then acquires the latest screen data from the frame buffer 16 and creates the screen update data in an MPEG format in which the beginning is a P-frame and in which difference data is created from the beginning in a state in which simulated I-frames are retained. The update difference video converting unit 22 outputs the created update data to the screen update notification unit 23 and notifies the client device 50 via the communication unit 11.

As one example, the update difference video converting unit 22 creates texture information by texture encoding after using the input images and simulated I-frames to conduct motion estimation and motion compensation. Conversely, the update difference video converting unit 22 uses the results of the motion compensation and the texture information to create new frames and writes the new frames into a buffer. The update difference video converting unit 22 also multiplexes motion vector information obtained from the motion estimation and texture information obtained from the texture encoding and writes the multiplexed information into a buffer. The update difference video converting unit 22 then reads out the data from the buffer and transmits the data as a bit stream to the client device 50.

Returning to FIG. 6, the screen update notification unit 23 transmits images created by the update difference image converting unit 20 to the client device 50. The screen update notification unit 23 also transmits video images, which are video images only formed from the P-frames, created by the update difference video converting unit 22 to the client device 50. The screen update notification unit 23 also retains the images (frames) transmitted up to the present time and the numbers assigned to those frames in association with each other.

The abovementioned processing units may use various types of integrated circuits or electronic circuits and some of the processing units may use another integrated circuit or electronic circuit. Examples of integrated circuits include an Application Specific Integrated Circuit (ASIC) or a Field Programmable Gate Array (FPGA). Examples of electronic circuits include a Central Processing Unit (CPU) or a Micro Processing Unit (MPU).

(Client Device Configuration)

As illustrated in FIG. 6, the client device 50 includes a communication unit 51, a display unit 52, a screen display unit 53, an operating information acquiring unit 54, and a client side remote screen control unit 55. In the example of FIG. 6, it is assumed that, besides the functional units illustrated in FIG. 6, a conventional computer includes various functional units such as various input devices and audio output units.

The communication unit 51 is a communication interface that sends and receives data to and from the server device 10. For example, the communication unit 51 transmits operating information acquired from the belowmentioned operating information acquiring unit 54 to the server device 10. The communication unit 51 also receives images and videos from the server device 10 and outputs the images to a screen update information acquiring unit 56 and the like.

The display unit 52 is a display device that displays various types of information such as a desktop screen transmitted from the server device 10. A monitor, a display, or a touch panel may be used as examples of the display unit 52. The display unit 52 also works in concert with an input device such as a mouse to provide a pointing device.

The screen display unit 53 reads out images written into the frame buffer 60, that is images and video images drawn in the frame buffer 60, and causes the images to be displayed on the display unit 52 as a remote screen. As a result, the images and videos transmitted from the server device 10 are displayed on the client device 50 so that a remote screen control service is provided.

The operating information acquiring unit 54 is a processing unit that acquires mouse and other operating information and notifies the server device 10 about the operating information. For example, the operating information acquiring unit 54 sends operating information such as mouse cursor movement amounts and the like obtained through mouse movement operations such as mouse right and left clicks, double-clicks, and dragging. As another example, the operating information acquiring unit 54 sends operating information such as mouse wheel scroll amounts and various types of keys pressed on a keyboard.

The client side remote screen control unit 55 is a processing unit that receives the remote screen control service provided by the server device 10 through a client side remote screen control application. As illustrated in FIG. 6, the client side remote screen control unit 55 includes the screen update information acquiring unit 56, an image data processing unit 57, a simulated I-frame processing unit 58, a video data processing unit 59, and a frame buffer 60.

The screen update information acquiring unit 56 is a processing unit that acquires from the communication unit 51 image data transmitted from the server device 10. The screen update information acquiring unit 56 then outputs the image data to the image data processing unit 57 if the acquired image data includes static images and the like. The screen update information acquiring unit 56 outputs the image data to the simulated I-frame processing unit 58 if the acquired image data includes video images such as P-frames and the like. The screen update information acquiring unit 56 is able to determine the image data type from an image data format or an encoding state and the like.

The image data processing unit 57 is a processing unit that writes the image data acquired from the screen update information acquiring unit 56 into the frame buffer 60. For example, the image data processing unit 57 draws the image data transmitted from the server device 10, that is, images updated by an operation by the client, into the frame buffer 60.

The simulated I-frame processing unit 58 is a processing unit that acquires region position information inside a frame to be processed from the video data in which the leading I-frame is removed and which is acquired from the screen update information acquiring unit 56. The simulated I-frame processing unit 58 acquires the screen data from the frame buffer based on the acquired region position information, and outputs the screen data to the video data processing unit 59 as simulated I-frames.

For example, the simulated I-frame processing unit 58 receives video update data of the screen starting from the P-frame, removes the update data and the screen data of the same region from the frame buffer 60 as simulated I-frames, and outputs the simulated I-frames to the video data processing unit 59. Specifically, the simulated I-frame processing unit 58 receives the update data in the video format and acquires coordinate information and the like from the update data as drawing position information. The simulated I-frame processing unit 58 then uses the position information to acquire the screen data of the corresponding region from the frame buffer 60, and outputs the screen data to the video data processing unit 59 as the simulated I-frames.

Specifically, the simulated I-frame processing unit 58 specifies the image data received immediately before receiving the video data from the server device 10 if the beginning of the acquired video data is a P-frame. The simulated I-frame processing unit 58 then outputs the acquired screen data, the specified image data, and the simulated I-frames to the video data processing unit 59.

The video data processing unit 59 uses the simulated I-frames acquired from the simulated I-frame processing unit 58 and data received from the server device 10 with the I-frames removed, to create video data. The video data processing unit 59 may use MPEG technology to create videos. For example, the video data processing unit 59 that is an MPEG decoder receives the simulated I-frames from the simulated I-frame processing unit 58 and also receives the video data starting having the P-frame at the beginning, and then draws the video data from the received data to the frame buffer 60.

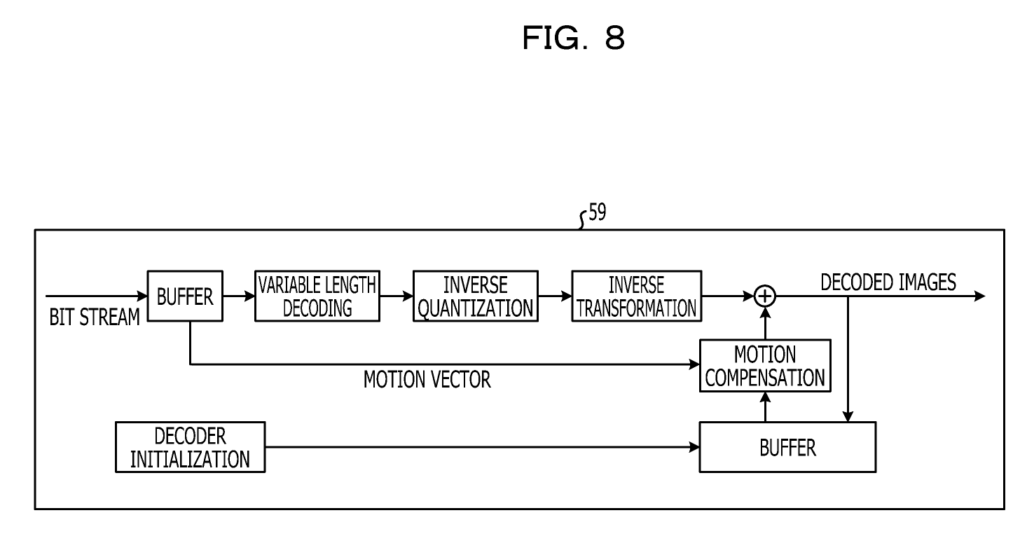

FIG. 8 illustrates an example of internal processing of a video data processing unit. As illustrated in FIG. 8, the video data processing unit 59 includes a buffer and conducts variable length decoding processing, inverse quantization, inverse transformation, and motion compensation and the like in the same way as a typical MPEG decoder to create decoded images. Among the processing conducted by the video data processing unit 59, a feature different from a typical decoder is that during decoding initialization, processing region frames are input into a buffer as I-frames. Detailed explanations of processing similar to that conducted by a typical decoder will be omitted.

Specifically, the video data processing unit 59 first writes the received simulated I-frames into a “buffer.” Due to this processing, screen drawing data created during decoding can be created from data that has been changed to the screen data currently being displayed in the frame buffer 60. The video data processing unit 59 then uses the simulated I-frames and the video data that begins with the P-frame to create screen update data from the frames in which P-frame differences are reflected. The video data processing unit 59 then writes the created data into the frame buffer 60.

Returning to FIG. 6, the frame buffer 60 retains images drawn by the image data processing unit 57 and video images created by the video data processing unit 59. For example, data of the results of the drawing processing conducted by the video data processing unit 59 and the like is written into the frame buffer 60. The frame buffer also retains images that become the source data of the simulated I-frames acquired by the simulated I-frame processing unit 58.

(Process Flow)

The following is an explanation of a processing flow conducted in the system according to the second embodiment. The processing flow conducted by the server device and the processing flow conducted by the client device will be described.

(Overall Process Flow Conducted By Server)

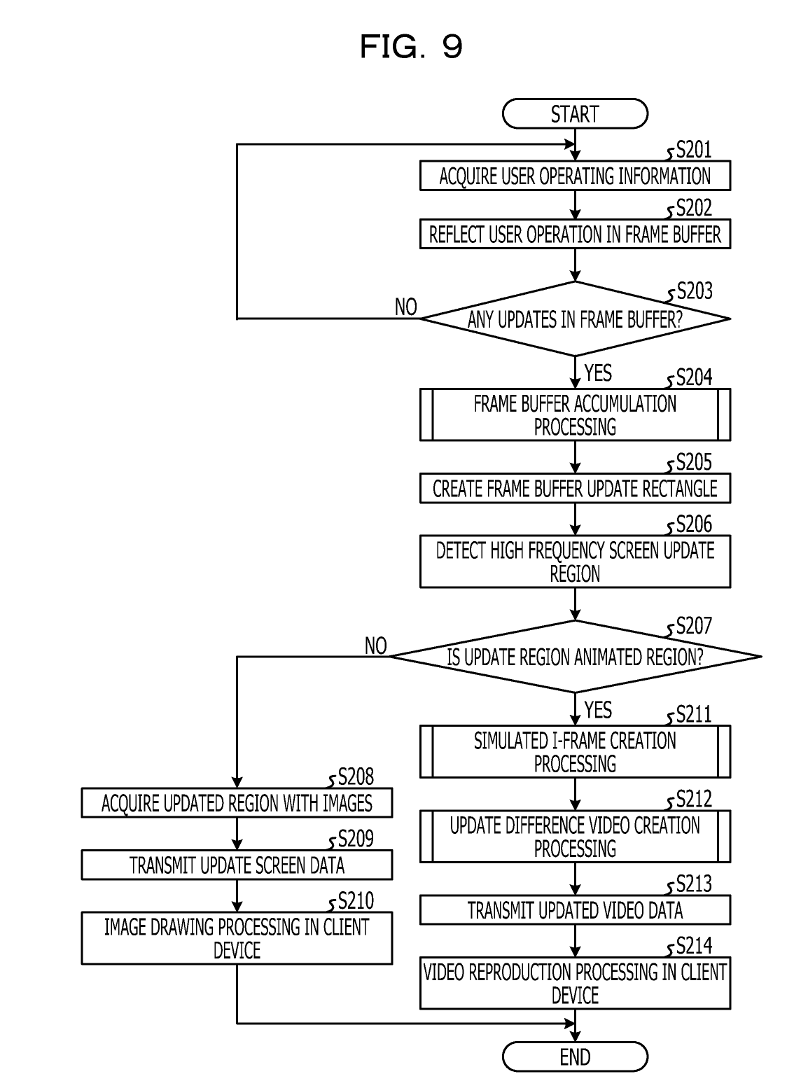

FIG. 9 is a flow chart of an overall process flow conducted by the server device according to the second embodiment. As illustrated in FIG. 9, the operating information acquiring unit 12 of the server device 10 acquires user operating information conducted in the client device 50 (S201). The display screen creating unit 14 creates a screen corresponding to the user operating information and reflects the screen in the frame buffer 16 (S202).

When the frame buffer accumulating unit 17 detects that an update has occurred in the frame buffer 16 as a result of the frames being reflected by the display screen creating unit 14 (S203 Yes), frame buffer accumulation processing is conducted (S204). If no occurrence of an update in the frame buffer 16 is detected by the frame buffer accumulating unit 17 (S203 No), the processing by the server device 10 returns to S201 to repeat the processing from that point.

The update difference creating unit 18 then creates a frame buffer 16 update rectangle from all the frame buffer information accumulated by the frame buffer accumulation processing (S205). Next, the high frequency screen update region detecting unit 19 detects a high frequency screen update region from the update rectangle created by the update difference creating unit 18 (S206). The high frequency screen update region detecting unit 19 then determines whether or not the detected high frequency screen update region is an animated region, that is, whether or not the updating is intense (S207).

If the high frequency screen update region is not an animated region (S207 No), the update difference image converting unit 20 acquires from the frame buffer 16 a region matching the updated difference from the updating frequency region and converts the updated difference to an image, and then outputs the converted image to the screen update notification unit 23 (S208). The screen update notification unit 23 transmits the difference images acquired from the update difference image converting unit 20 to the client device 50 via the communication unit 11 (S209). Image drawing processing is then conducted in the client device 50 (S210).

Alternatively, if the high frequency screen update region is an animated region (S207 Yes), the simulated I-frame processing unit 21 conducts simulated I-frame creation processing (S211) and then the update difference video converting unit 22 conducts update difference video creation processing (S212).

The screen update notification unit 23 then transmits the video data with only the P-frames and without the I-frames to the client device 50 via the communication unit 11 (S213). Video reproduction processing is then conducted in the client device 50 (S214).

(Frame Buffer Accumulation Processing)

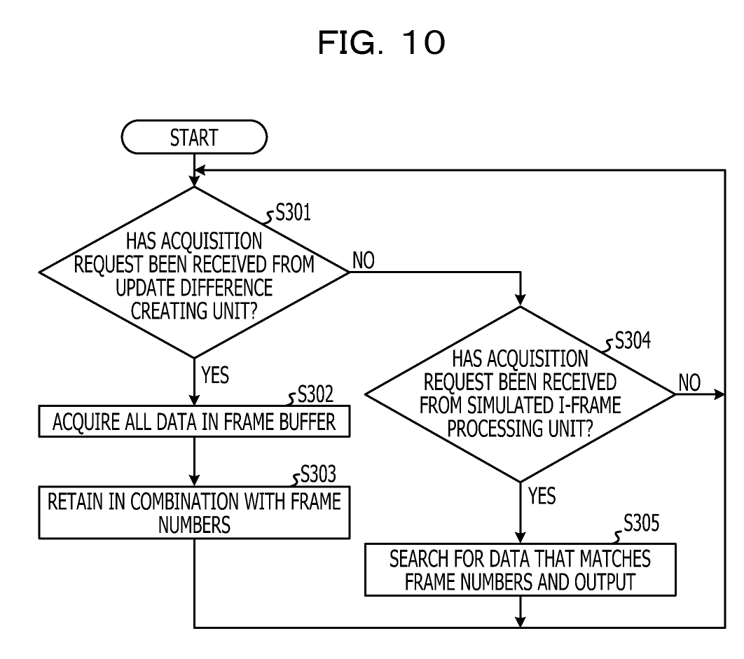

FIG. 10 is a flow chart of frame buffer accumulation processing conducted by the server device according to the second embodiment. This processing is conducted in S204 of FIG. 9.

As illustrated in FIG. 10, when the frame buffer accumulating unit 17 receives an acquisition request from the update difference creating unit 18 (S301 Yes), the frame buffer accumulating unit 17 acquires all the data in the frame buffer 16 (S302) and then adds a unique frame numbers and retains the data (S303).

Conversely, if no acquisition request is received from the update difference creating unit 18 (S301 No), and if an acquisition request is received from the simulated I-frame processing unit 21 (S304 Yes), the frame buffer accumulating unit 17 proceeds to S305. Specifically, the frame buffer accumulating unit 17 searches for data that matches the frame numbers included in the acquisition request and outputs the detected data to the simulated I-frame processing unit 21 (S305). If no acquisition request is received from the update difference creating unit 18 (S301 No), and no acquisition request is received from the simulated I-frame processing unit 21 (S304 No), the frame buffer accumulating unit 17 returns to S301 to conduct the processing from that point.

(Simulated I Frame Creation Processing)

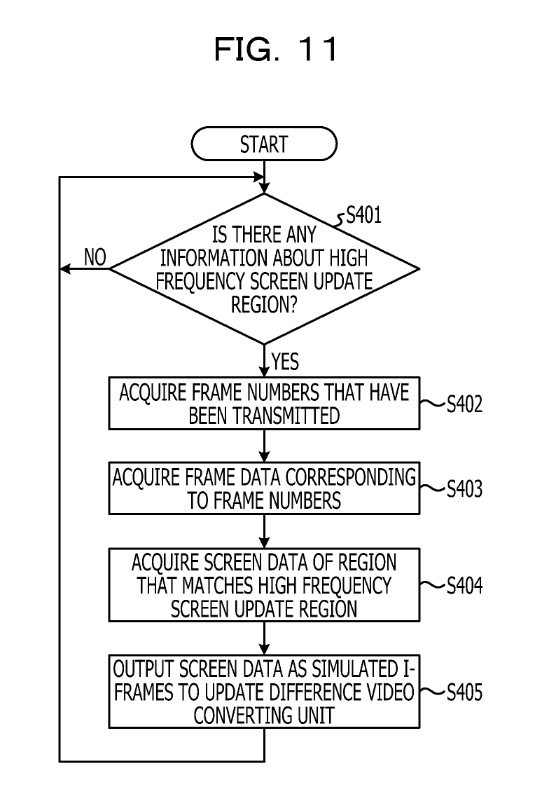

FIG. 11 is a flow chart of simulated I-frame creation processing conducted by the server device according to the second embodiment. This processing is conducted in S211 of FIG. 9. This processing is conducted when a high frequency screen is detected.

As illustrated in FIG. 11, when the simulated I-frame processing unit 21 is notified by the update difference image converting unit 20 that a high frequency screen exists (S401 Yes), the simulated I-frame processing unit 21 acquires from the screen update notification unit 23 the latest frame numbers that have been transmitted (S402).

Next, the simulated I-frame processing unit 21 acquires from the frame buffer accumulating unit 17 the frame data corresponding to the latest frame numbers that have been transmitted (S403). The simulated I-frame processing unit 21 then also acquires the high frequency screen update region from the update difference image converting unit 20 and the screen data of the region that matches the acquired high frequency screen update region from the frame buffer accumulating unit 17 (S404). The simulated I-frame processing unit 21 outputs the acquired screen data to the update difference video converting unit 22 as simulated I-frames (S405).

(Update Difference Video Creation Processing)

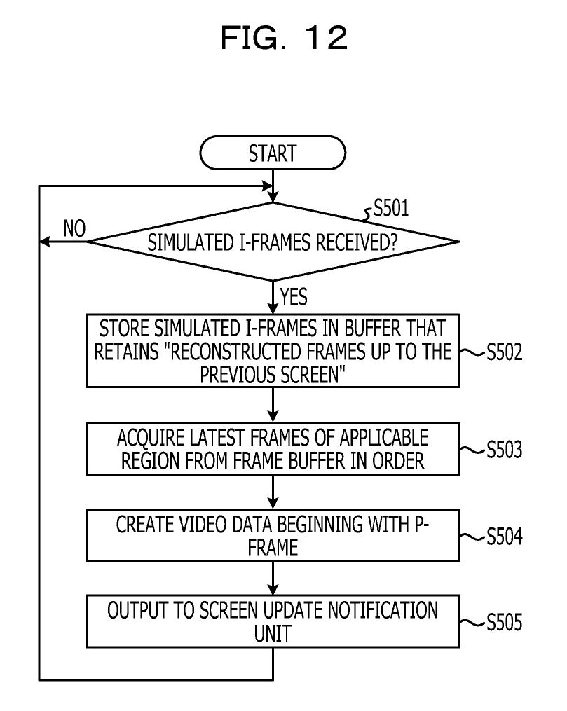

FIG. 12 is a flow chart of update difference video creation processing conducted by the server device according to the second embodiment. This processing is conducted in S212 of FIG. 9. This processing is conducted whenever a simulated frame is received.

As illustrated in FIG. 12, when the update difference video converting unit 22 receives simulated I-frames from the simulated I-frame processing unit 21 (S501 Yes), the update difference video converting unit 22 stores the simulated I-frames in the buffer that retains the “reconstructed frames up to the previous screen” (S502).

The update difference video converting unit 22 then acquires from the frame buffer 16 the latest frames of the high frequency screen update region, that is, the region in which intense operations are conducted (S503), and creates video data beginning with a P-frame (S504). The update difference video converting unit 22 then outputs the created video data to the screen update notification unit 23 (S505).

(Overall Process Flow Conducted By Client Device)

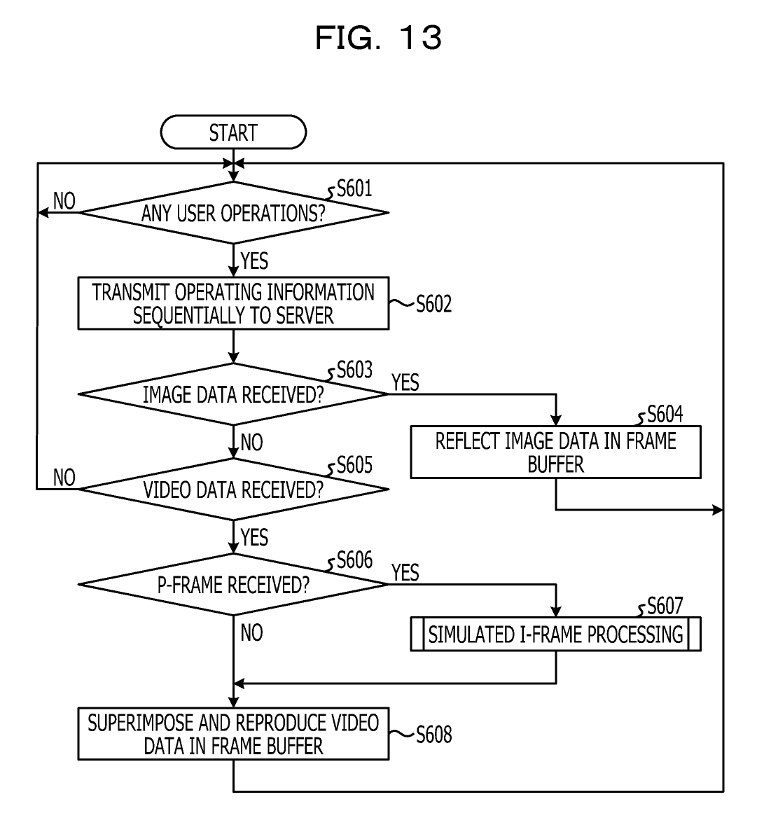

FIG. 13 is a flow chart of an overall flow of processing conducted by the client device according to the second embodiment. As illustrated in FIG. 13, when a user conducts an operation on a screen displayed on the display unit 52 (S601 Yes), the operating information acquiring unit 54 of the client device 50 sequentially transmits operating information indicating the contents of the operation to the server device 10 (S602).

If the screen update information acquiring unit 56 receives the image data from the server device 10 (S603 Yes), the image data processing unit 57 draws the received image data in the frame buffer 60 (S604).

Conversely, if the screen update information acquiring unit 56 does not receive image data from the server device 10 (S603 No), and instead receives video data (S605 Yes), the simulated I-frame processing unit 58 determines whether or not the beginning of the received video data is a P-frame (S606).

The simulated I-frame processing unit 58 then conducts simulated I-frame processing (S607) if the beginning of the received video data is a P-frame (S606 Yes). The video data processing unit 59 also creates the video data in S606. The video data processing unit 59 then superimposes the created moving data in the frame buffer 60 to reproduce the video data (S608). The simulated I-frame processing unit 58 does not conduct the processing in S607 if the beginning of the received video data is not an I-frame instead of a P-frame (S606 No). Instead, the simulated I-frame processing unit 58 then superimposes the created moving data in the frame buffer 60 to reproduce the video data (S608).

(Simulated I-Frame Processing)

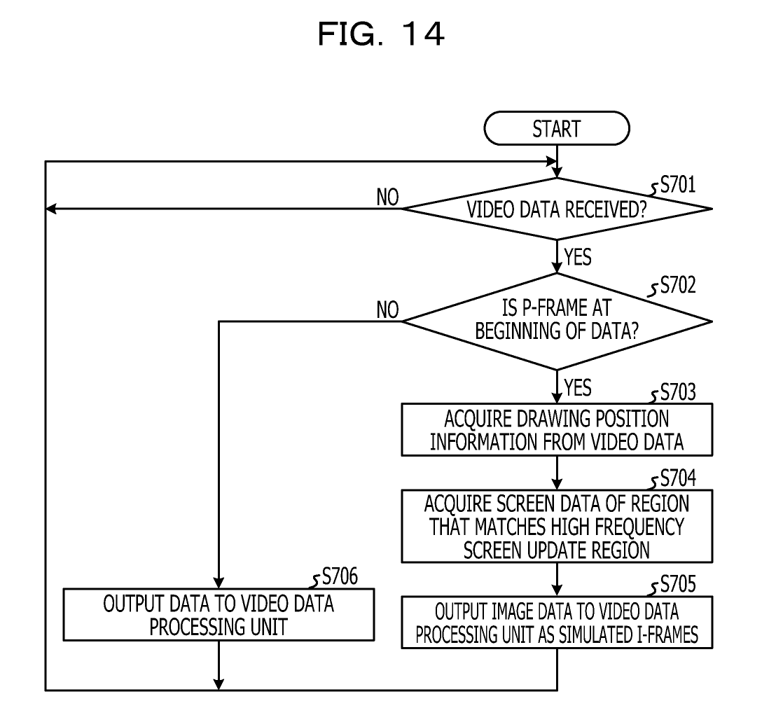

FIG. 14 is a flow chart of simulated I-frame processing conducted by the client device according to the second embodiment. This processing is conducted from S605 to S608 of FIG. 13. This processing is conducted whenever video data is received.

As illustrated in FIG. 14, if the video data is received from the screen update information acquiring unit 56 (S701 Yes) and the beginning of the data is a P-frame (S702 Yes), the simulated I-frame processing unit 58 acquires drawing position information from the video data (S703).

The simulated I-frame processing unit 58 then acquires the screen data region that matches the high frequency screen update region at the acquired drawing position (S704). The simulated I-frame processing unit 58 outputs the acquired screen data to the video data processing unit 59 as the simulated I-frames (S705).

Conversely, if the beginning of the video data received from the screen update information acquiring unit 56 is not a P-frame (S702 No), the received video data is output to the video data processing unit 59 (S706).

(Video Data Processing)

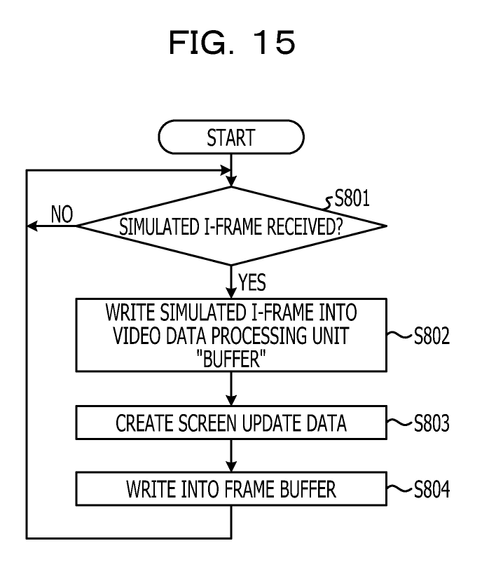

FIG. 15 is a flow chart of video data processing conducted by the client device according to the second embodiment. This processing is conducted in S607 of FIG. 13. This processing is conducted whenever a simulated I-frame is received.

As illustrated in FIG. 15, when simulated I-frames are received from the simulated I-frame processing unit 58 (S801 Yes), the video data processing unit 59 writes the received simulated I-frames into a buffer and the like inside the video data processing unit 59 (S802).

The video data processing unit 59 uses the simulated I-frames and video data received from the server device 10 with the I-frames removed, to create screen update data (S803). The video data processing unit 59 then writes the screen update data into the frame buffer 60(S804).

(Effects of the Second Embodiment)

According to the second embodiment, a large amount of cache data can be avoided, the duplication of data when switching screen data processing methods can be reduced, and the amount of transmitting data at the start of updating can be reduced. Moreover, the disclosed processing may be applied only when there is a high possibility that a large amount of updating will occur by using an operation trigger such as mouse operating information and the like. Moreover, updating can be conducted when the communication volume is low by storing a location of a screen region updated in the processing of the second embodiment, and a high quality image can be maintained even if the communication volume is low.

### Embodiment 3

The system disclosed herein retains the image compression format used when transmitting screen update data as images to a client device, and acquires image compression format information when acquiring simulated I-frames. This system may create more accurate simulated I-frames by using the acquired image compression format information on screen data acquired from a frame buffer accumulating unit.

A third embodiment will now be described as an example in which the image compression format information is retained to create accurate simulated I-frames. The following is a description of configurations of devices, processing flows, and effects. The configuration of the client device is the same as described above in the second embodiment and thus a detailed explanation will be omitted.

(Configurations of Devices)

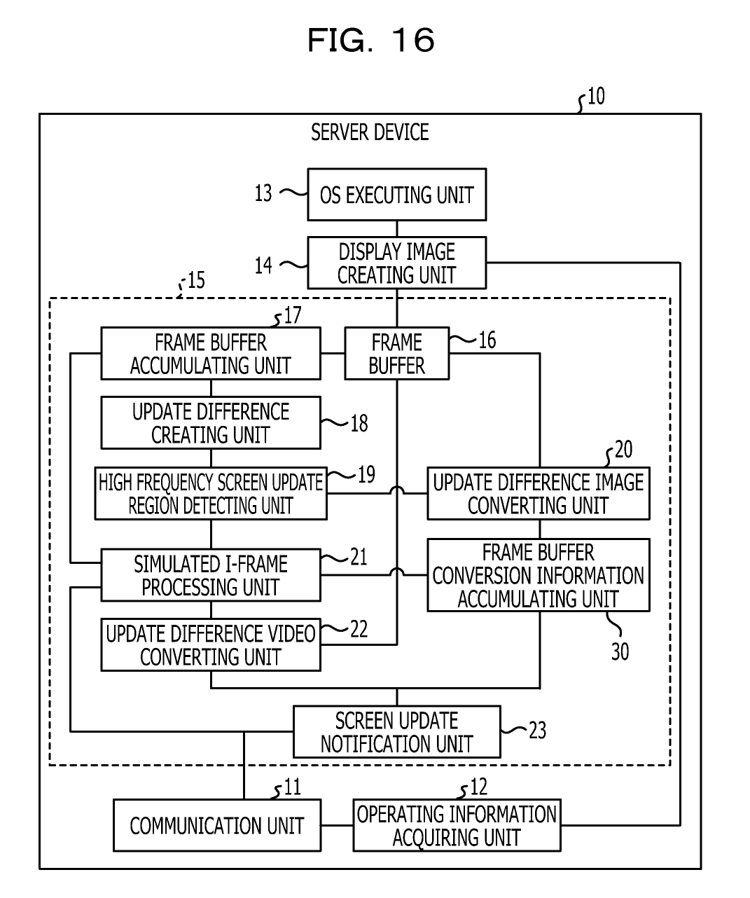

FIG. 16 is a block diagram of a configuration of a server device according to the third embodiment. As illustrated in FIG. 16, the server device 10 includes a communication unit 11, an operating information acquiring unit 12, an OS executing unit 13, a display screen creating unit 14, and a server side remote screen controlling unit 15. The communication unit 11, the operating information acquiring unit 12, the OS execution unit, and the display screen creating unit 14 have the same configurations as described above in FIG. 6, and thus detailed explanations will be omitted.

The server side remote screen controlling unit 15 includes a frame buffer 16, a frame buffer accumulating unit 17, an update difference creating unit 18, a high frequency screen update region detecting unit 19, and an update difference image converting unit 20. The server side remote screen controlling unit 15 also includes a simulated I-frame processing unit 21, an update difference video converting unit 22, and a screen update notification unit 23. The server side remote screen controlling unit 15 further includes a frame buffer conversion information accumulating unit 30. Processing units other than the frame buffer conversion information accumulating unit 30 conduct the same processing as illustrated in FIG. 6 and detailed explanations will be omitted.

The frame buffer conversion information accumulating unit 30 retains an image compression format to be used on data transmitted to the client device. For example, the frame buffer conversion information accumulating unit 30 acquires and retains updated region information and a conversion method used in the update difference video converting unit 22. Upon receiving the high frequency screen update region information, the simulated I-frame processing unit 21 conducts a search in the frame buffer conversion information accumulating unit 30 using the region information as a search key. If there is a match, the simulated I-frame processing unit 21 then re-expands the corresponding region acquired from the frame buffer 16 and uses the region as a simulated I-frame while adopting the compression method.

(Process Flow)

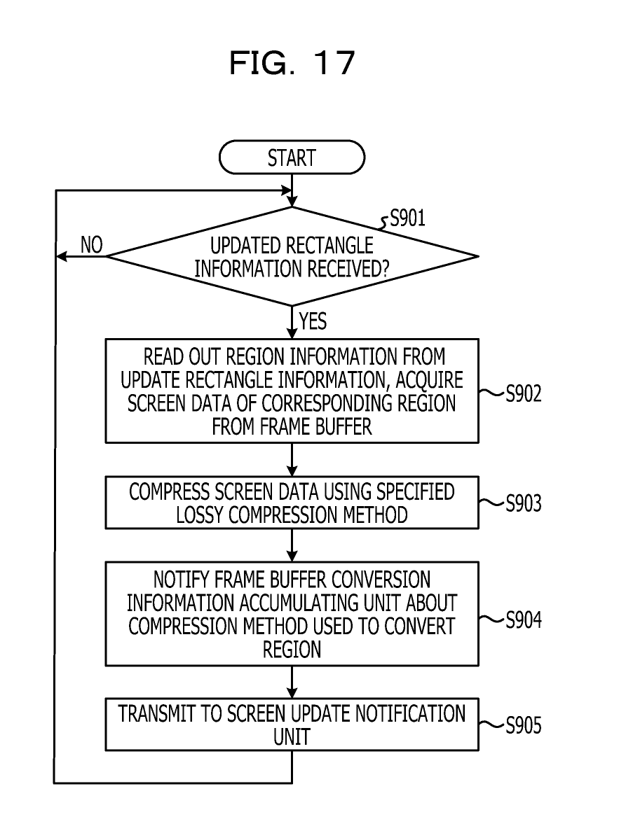

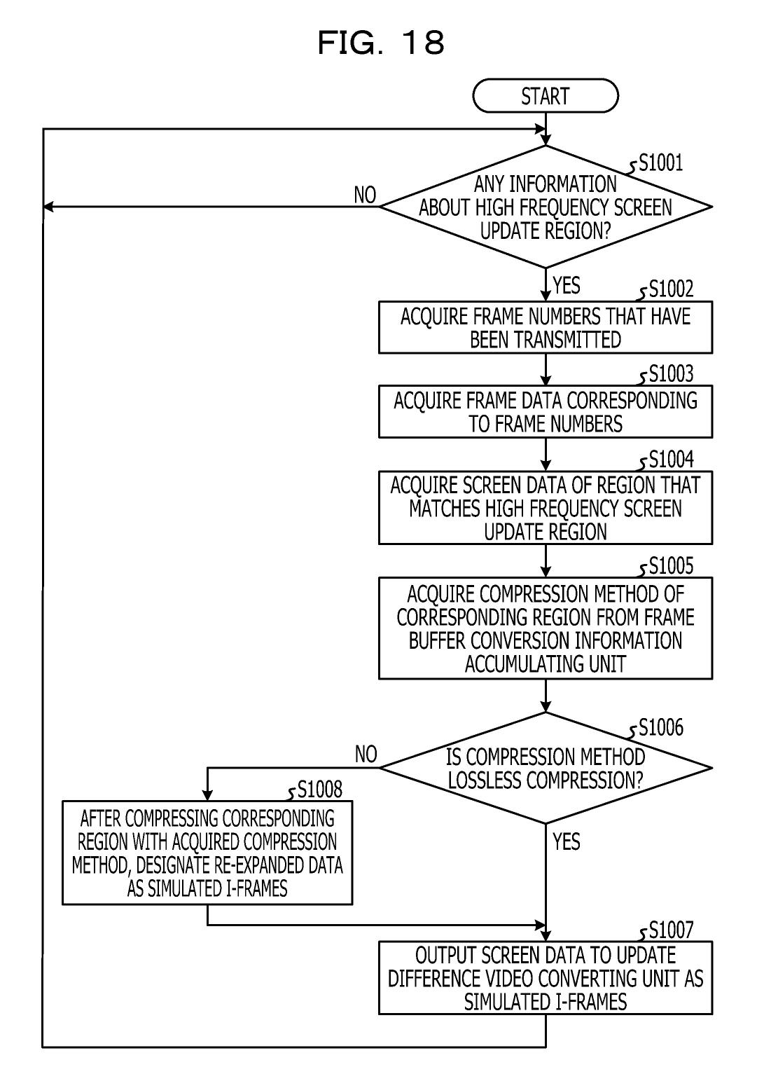

Next, processing conducted by the server device according to the third embodiment will be described with reference to FIGS. 17 and 18. Update difference image conversion processing and simulated I-frame creation processing will be described as processes different from those of the second embodiment.

(Update Difference Image Conversion Processing)

FIG. 17 is a flow chart of update difference video creation processing conducted by the server device according to the third embodiment. As illustrated in FIG. 17, the update difference image converting unit 20 conducts the processing in S902 when updated rectangle information is received from the high frequency screen update region detecting unit 19 (S901 Yes). Specifically, the update difference image converting unit 20 reads the region information from the updated rectangle information and acquires the screen data of the corresponding region from the frame buffer 16 (S902).

The update difference image converting unit 20 then compresses the data using either a lossy compression method determined in advance with the client device 50, or a lossy compression method used when the previous screen data was created (S903). The update difference image converting unit 20 associates the information of the region in which the screen data was created with the compression method, notifies the frame buffer conversion information accumulating unit 30 (S904), and then outputs the created screen data to the screen update notification unit 23 (S905).

(Simulated I-Frame Creation Processing)

FIG. 18 is a flow chart of simulated I-frame creation processing conducted by the server device according to the third embodiment. As illustrated in FIG. 18, when the simulated I-frame processing unit 21 is notified by the update difference image converting unit 20 that a high frequency screen exists (S1001 Yes), the simulated I-frame processing unit 21 acquires from the screen update notification unit 23 the latest frame numbers that have been transmitted (S1002).

Next, the simulated I-frame processing unit 21 acquires from the frame buffer accumulating unit 17 frame data corresponding to the latest frame numbers that have been transmitted (S1003). The simulated I-frame processing unit 21 then also acquires the high frequency screen update region from the update difference image converting unit 20 and the screen data of the region that matches the acquired high frequency screen update region from the frame buffer accumulating unit 17 (S1004). The simulated I-frame processing unit 21 also acquires the compression method of the corresponding region from the frame buffer conversion information accumulating unit 30 (S1005).

If the acquired compression method is lossless compression (S1006 Yes), the simulated I-frame processing unit 21 outputs the screen data acquired in S1004 to the update difference video converting unit 22 as simulated I-frames (S1007).

Conversely, if the acquired compression method is lossy compression (S1006 No), the simulated I-frame processing unit 21 outputs the screen data acquired in S1004 to the update difference video converting unit 22 as simulated I-frames of re-expanded data after compressing the screen data acquired in S1004 using the acquired compression method (S1008).

(Effects of Third Embodiment)

It is assumed that the same items exist in the frame buffers of both the client device and the server device. In this way, when transferring the same data during a screen data transfer, a method using a relatively large amount of data called a lossless compression method is desired for compressing images. As a result, screen data can also be compressed using a lossy compression method that can reduce the amount of data by allowing for the deletion of data. However, when the screen data is transmitted to the client using the lossless compression method, there is a possibility that there will be a loss of consistency between the frame buffers in the server and those of the client.

However according to the third embodiment, the same simulated I-frames can be created in the client device and the server device by adding the “frame buffer conversion information accumulating unit 30” to the server device 10 to allow for retaining the compression method and compression quality for each region.

### Embodiment 4

The disclosed system may reduce the data transfer amounts by removing the I-frames without modifying the existing MPEG encoder or decoder. Thus the fourth embodiment will describe an example of removing I-frames without modifying the existing MPEG encoder or decoder. The following is a description of configurations of devices, processing flows, and effects. The configuration of the client device is the same as described above in the second embodiment and thus a detailed explanation will be omitted.

(Configurations of devices)

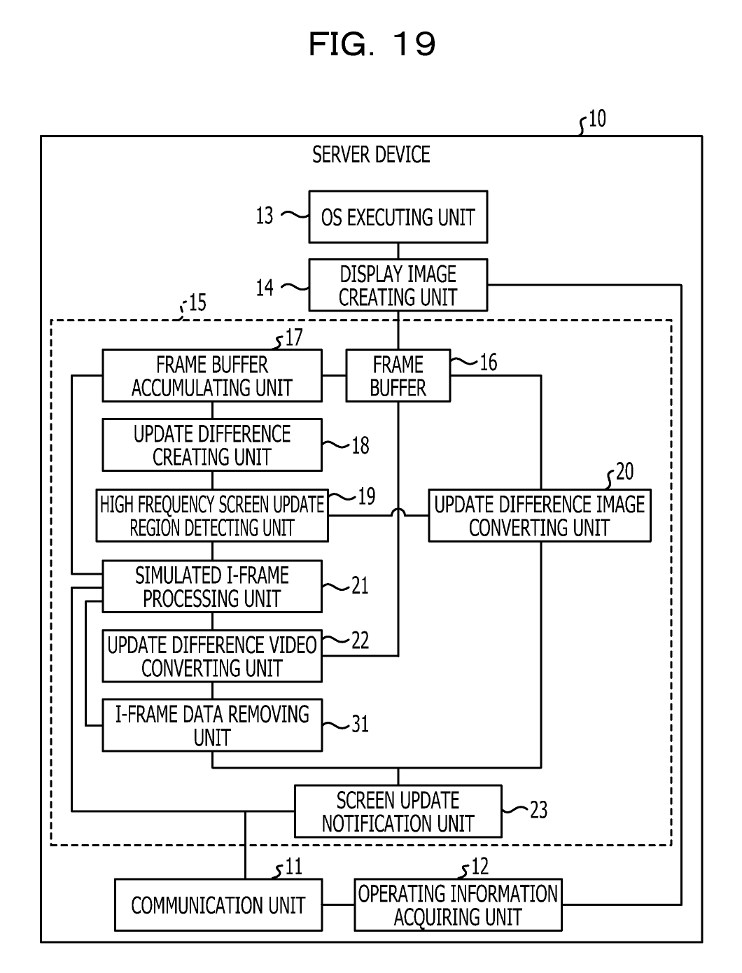

FIG. 19 is a block diagram of a configuration of a server device according to the fourth embodiment. As illustrated in FIG. 19, the server device 10 includes a communication unit 11, an operating information acquiring unit 12, an OS executing unit 13, a display screen creating unit 14, and a server side remote screen controlling unit 15. The communication unit 11, the operating information acquiring unit 12, the OS execution unit, and the display screen creating unit 14 have the same configurations as described above in FIG. 6, and thus detailed explanations will be omitted.

The server side remote screen controlling unit 15 includes a frame buffer 16, a frame buffer accumulating unit 17, an update difference creating unit 18, a high frequency screen update region detecting unit 19, and an update difference image converting unit 20. The server side remote screen controlling unit 15 also includes a simulated I-frame processing unit 21, an update difference video converting unit 22, and a screen update notification unit 23. The server side remote screen controlling unit 15 also includes an I-frame data removing unit 31. Processing units other than the I-frame data removing unit 31 conduct the same processing as illustrated in FIG. 6 and detailed explanations will be omitted.

The I-frame data removing unit 31 is a processing unit that removes data of the leading I-frame from MPEG data created by the simulated I-frame processing unit 21. For example, when a notification to remove the I-frame is received from the simulated I-frame processing unit 21, the I-frame data removing unit 31 removes the I-frame from the beginning of the MPEG data received from the simulated I-frame processing unit 21, and outputs the MPEG data to the screen update notification unit 23.

(Process Flow)

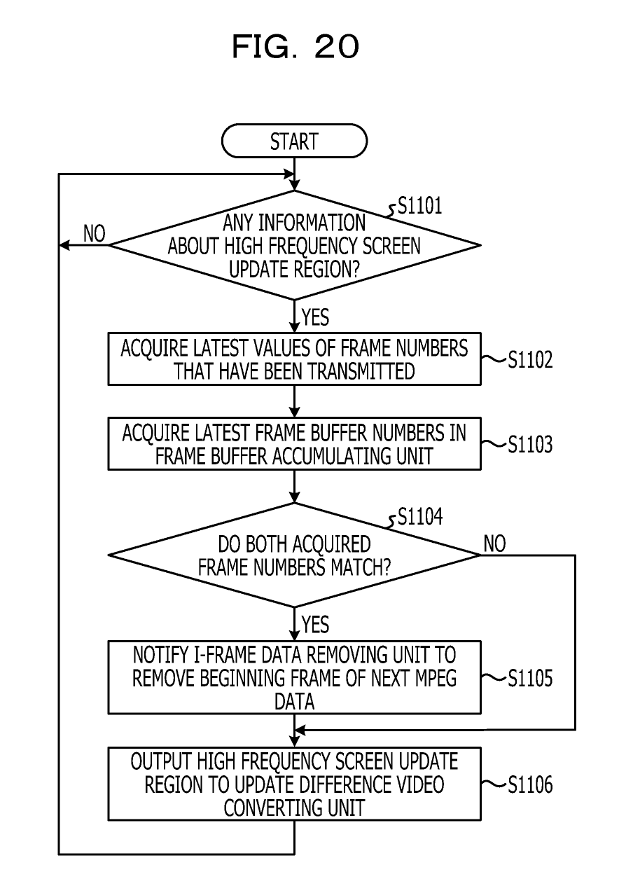

FIG. 20 is a flow chart of simulated I-frame creation processing conducted by the server device according to the fourth embodiment. As illustrated in FIG. 20, the simulated I-frame processing unit 21 receives a high frequency screen update region from the high frequency screen update region detecting unit 19 (S1101 Yes). The simulated I-frame processing unit 21 then acquires the latest values of the transmitted frames from the screen update notification unit 23 (S1102), and acquires the latest frame buffer numbers accumulated in the frame buffer accumulating unit 17 (S1103).

The simulated I-frame processing unit 21 then determines whether or not the frame number acquired from the screen update notification unit 23 and the frame number acquired from the frame buffer accumulating unit 17 match (S1104). Since newer screen data is written in the frame buffer accumulating unit 17 first, if data corresponding to the I-frame created when creating the moving data has not reached the client due to the timing of the processing, old frame numbers of the screen update notification unit 23 may exist. In this case, there is a possibility that the simulated I-frames may not have been created even if data starting with a P-frame is transmitted to the client. Thus the matching determination is carried out in case the above occurs.

If both frame numbers match (S1104 Yes), the simulated I-frame processing unit 21 outputs a notification to the I-frame data removing unit 31 to remove the leading I-frame from the next MPEG data, that is, the MPEG data to be transmitted next. If the frame numbers do not match (S1104 No), the simulated I-frame processing unit 21 does not conduct the processing in S1105 and proceeds to S1106.

The simulated I-frame processing unit 21 then outputs the high frequency screen update region received from the high frequency screen update region detecting unit 19 to the update difference video converting unit 22 (S1106). As a result, the I-frame data removing unit 31 removes the leading I-frame of the MPEG data acquired from the update difference video converting unit 22, and outputs the MPEG data to the screen update notification unit 23.

(Effects of Fourth Embodiment)

In this way, the server device further includes the “I-frame data removing unit 31” so that the created MPEG data with the leading I-frame data removed is transferred to the client device. The amount of data transferred to the client device can be reduced by adding a simulated I-frame acquired from the client device's own frame buffer to the beginning of the received MPEG data.

### Embodiment 5

The present disclosure may be implemented in various different modes other than the embodiments of the present disclosure described above. The following describes another embodiment.

(Transmission Method Switching)

The present embodiment is not limited to examples of switching from image transmission to video transmission described in embodiments 1 to 4. For example, the system disclosed herein may be used for switching to another video data format after the video data is updated, or for switching to another image data format after the video data is updated.

Moreover, the example of the switching trigger, in other words the intense operation, may be detected by the server device when an intense operation is conducted if the period of time from the detection of a mouse down-click in the client device to the detection of a mouse up-click corresponds to a specific period of time. Moreover, an intense operation may be detected by the server device when a distance from a down-click to an up-click meets or exceeds a specific value.

(Return to Transmission Method)

For example, a timing to return to the original image transmission after switching from image transmission to video transmission may be freely set in the methods described in the first to fourth embodiments. For example, the transmission method may be returned to the original method after a fixed timing during which the region is animated, or when a fixed time of a state in which updates are few has elapsed.

(Video Compression)

Although I-frames and P-frames were described as examples used in the MPEG technology in the first to fourth embodiments, other video compression methods besides the MPEG technology may be used within the scope of the system disclosed herein. Specifically, the I-frame and P-frame exemplified in the embodiments respectively correspond to a reference image and a difference image used in typical video compression methods.

(System)

Among the processing described in the present embodiment, all or some of the processing described as being conducted automatically may be conducted manually. Conversely, all or some of the processing described as being conducted manually may be conducted automatically using known methods. The procedures, the control procedures, the specific names, and information including various kinds of data and parameters, such as those illustrated in FIG. 3, that have been described in the specification and illustrated in the drawings may be altered, unless specified in particular.

The constituent elements of the illustrated parts are functional and conceptual perspectives and do not have to be configured physically as illustrated. That is, the decentralization and integration of the components are not limited to those illustrated in the drawings. That is, all or some of the components may be functionally or physically decentralized or integrated according to each kind of load and usage. All or a part of the processing functionality implemented by the components may be performed by a CPU and a program that is analyzed and executed by the CPU, or may be implemented as hardware with wired logic.

Moreover, an operating information acquiring unit described in the embodiments may be a sensor such as an acceleration sensor, an optic sensor, a geomagnetic sensor, or a temperature sensor that can sense user operations on a terminal and user periphery conditions. The operating information acquiring unit may also be a device such as a touch panel, keyboard, or microphone in which the user conducts direct inputs. Although the client server used in the above embodiments can output a desktop environment of the same size as on a server device, the embodiments are not limited as such. For example, a terminal with a small screen size such as a PDA, a notebook PC, a mobile game, a mobile music player and the like can be used by reducing the display size of the screen. Furthermore, the OS execution unit on the server side may be any type of OS without depending on a specialized architecture.

(Program)

The processing of the various functions described in the present embodiment may be realized by executing a program prepared in advance using a computer system such as a personal computer or a workstation. In the following description, an example of a computer executing a program that has functions similar to the above embodiments will be described.

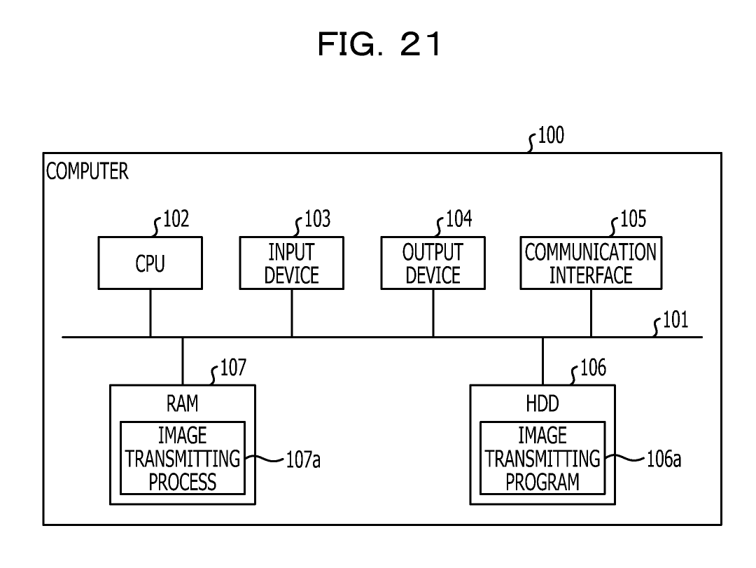

FIG. 21 is a block drawing of a hardware configuration of a computer that executes an image transmitting program. As illustrated in FIG. 21, a computer system 100 includes a CPU 102, an input device 103, an output device 104, a communication interface 105, a Hard Disk Drive (HDD) 106, and a Random Access Memory (RAM) 107 all interconnected by a bus 101.

The input device 103 is a mouse and a keyboard, the output device 104 is a display and the like, and the communication interface 105 is an interface such as a Network Interface Card (NIC). The HDD 106 stores an image transmitting program 106a as well as information stored in the buffers and the like illustrated in FIG. 6 and the like. The HDD 106 is exemplified as an example of a recording medium. However, the HDD 106 may also be a recording medium such as a computer-readable Read Only Memory (ROM), a Random Access Memory (RAM), or a CD-ROM and the like in which is stored various programs that are read by a computer. A storage medium may also be used by being arranged in a remote location so that a computer can acquire programs by accessing the storage medium. Moreover, the acquired programs may also be stored in a recording medium of the computer itself when used.

The CPU 102 activates an image transmitting process 107a that conducts the various functions described in FIG. 6 and the like by reading out the image transmitting program 106a and expanding the image transmitting program 106a in the RAM 107. Specifically, the image transmitting process 107a executes the same functions as the processing units included in the server side remote screen controlling unit 15 described in FIGS. 6, 16, and 19. In this way, the computer system 100 operates as an information processor apparatus that executes a remote screen transmission control method by reading and executing programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus that creates video data for displaying a computer execution result on a display unit of a terminal device connected via a network and transmits the video data to the terminal device, the information processing apparatus comprising:
a memory for storing time sequential static image data constituting the video data; and
a processor for
a first transmitting the time sequential static image data constituting the video data in order to the terminal device, and
a second transmitting, alternatively with the first transmitting, after creating and transmitting reference image data that becomes a reference in the time sequential static image data constituting the video data, difference image data from previous static image data in order;
wherein the second transmitting does not transmit the reference image data and transmits a signal indicating that the last static image data transmitted by the first transmitting is to be reference image data, when switched from the first transmitting.

2. The information processing apparatus according to claim 1 wherein, the first transmitting is switched to the second transmitting when an update region updated from previous static image data in the time sequential static image data constituting the video data meets or exceeds a specific value.

3. The information processing apparatus according to claim 1 wherein, the second transmitting creates the reference image data according to a compression method used when the first transmitting creates static image data.

4. An information processing method that creates video data for displaying a computer execution result on a display unit of a terminal device connected via a network and transmits the video data to the terminal device, the information processing method comprising:
a first transmitting the time sequential static image data constituting the video data in order to the terminal device, and
a second transmitting, alternatively with the first transmitting, after creating and transmitting reference image data that becomes a reference in the time sequential static image data constituting the video data, difference image data from previous static image data in order;
wherein the second transmitting does not transmit the reference image data and transmits a signal indicating that the last static image data transmitted by the first transmitting is to be reference image data, when switched from the first transmitting.

5. A computer-readable medium that stores an information processing program that causes a computer to execute an information processing method that creates video data for displaying a computer execution result on a display unit of a terminal device connected via a network and transmits the video data to the terminal device, the information processing program causing the computer to execute a procedure comprising:
a first transmitting the time sequential static image data constituting the video data in order to the terminal device, and
a second transmitting, alternatively with the first transmitting, after creating and transmitting reference image data that becomes a reference in the time sequential static image data constituting the video data, difference image data from previous static image data in order;
wherein the second transmitting does not transmit the reference image data and transmits a signal indicating that the last static image data transmitted by the first transmitting is to be reference image data, when switched from the first transmitting.
